(19) United States
(12) Patent Application Publication
(10) Pub. No.: US 2007/0271493 A1
(43) Pub. Date: Nov. 22, 2007

(54) Unequal error protection method and apparatus using the same

(75) Inventors: Ji-sung Oh, Seongnam-si (KR); Huaning Niu, San Jose, CA (US); Pengfei Xia, San Jose, CA (US); Ki-bo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/723,833

(22) Filed: Mar. 22, 2007

Related U.S. Application Data
(60) Provisional application No. 60/800,428, filed on May 16, 2006.

(30) Foreign Application Priority Data
Sep. 22, 2006 (KR) 10-2006-0092563

(51) Int. Cl. G06F 11/10

(52) U.S. Cl. 714/755

(57) ABSTRACT

An unequal-error-protection method is disclosed. The method includes performing error-correction coding in parallel; and performing symbol mapping by applying one of a plurality of gains to each of the plurality of error-correction-coded bit streams.

### CROSS-REFERENCE TO RELATED APPLICATION

This application claims priority from Korean Patent Application No. 10-2006-0092563 filed on Sep. 22, 2006 in the Korean Intellectual Property Office, and U.S. Provisional Patent Application No. 60/800,428 filed on May 16, 2006 in the United States Patent and Trademark Office, the disclosures of which are incorporated herein by reference in their entirety.

### BACKGROUND OF THE INVENTION

1. Field of the Invention

Methods and apparatuses consistent with the present invention relate to wireless communication technology. More particularly, the present invention relates to an unequal-error-protection method and an apparatus using the same.

2. Description of the Related Art

Widespread use of the Internet and wireless communication has increased demand for multimedia services that stream media over the Internet and wireless channels. In Internet Protocol (IP) networks, multimedia data can be provided by a server, and can be streamed by one or more wired or wireless clients. Wired connections include telephone networks, integrated services digital networks (ISDNs), cable networks, digital subscriber line networks (collectively referred to as xDSL), fiber networks, local area networks (LANs), wide area networks (WAN) and others. Electronic devices utilizing wireless communications include telephones (e.g., cell phones), personal data assistants (PDAs), hand-held and portable computers and others.

In most, if not all of these applications, bandwidth requirements and restrictions necessitate that multimedia data processing utilize a source encoder incorporating multimedia compression algorithms to analyze, quantify and represent multimedia data to convey the maximum information by expending a minimum number of bits. Characteristics of such algorithms vary significantly which leads to large scale variations in their performance (such as compression efficiency and bit rate). Characteristics of multimedia processing using compression algorithms can vary significantly based on content, which can lead to large scale variations in their performance (such as compression efficiency and bit rate)

High Definition television (HDTV) has become an increasingly popular format for viewing television programming. An increasing number of consumers are purchasing High Definition televisions (HDTVs). To keep up with this trend, cable operators have begun offering HD television programs to customers, and have also started deploying HD “on-demand” (OD) services.

Research on transmitting uncompressed audio or video data (hereinafter, called “uncompressed AV data”) between wireless devices using the large bandwidth of millimeter wave (mmWave) is being conducted. Compressed AV data is lossily compressed (parts that humans are less sensitive to are discarded) through processes such as motion compensation, DCT conversion, quantization and variable-length encoding. Hence, in the case of compressed AV data, the image quality can be deteriorated by compression loss, and AV data compression and restoration between a transmitting device and a receiving device should follow the same standard, which creates problems. In contrast, since uncompressed data includes digital values (e.g., R, G and B elements) which represent pixels as they are, a clear image quality can be provided, which is advantageous.

Such uncompressed AV data includes unimportant bits as well as important bits. Since important bits give high effect on the quality of sound and images, if an error occurs in important bits, it is more difficult to restore the original sound and images than the case where an error occurs in unimportant bits. However, if error protection is applied to all data, many data processes will be required, which greatly increases the amount of data to be transmitted. Hence, there is a need for a technology that can provide unequal error protection depending on the importance of the data.

### SUMMARY OF THE INVENTION

An object of the present invention is to transmit data efficiently and stably.

The present invention will not be limited to the technical objects described above. Other objects not described herein will be more definitely understood by those in the art from the following detailed description.

According to an exemplary embodiment of the present invention, there is provided an unequal-error-protection method including: performing error-correction coding in parallel; and performing symbol mapping by applying one of a plurality of gains to each of the plurality of error-correction-coded bit streams.

According to an exemplary embodiment of the present invention, there is provided an unequal-error-protection method including: performing error-correction coding on a plurality of bit streams; multiplexing the plurality of bit streams into a predetermined number of integrated bit streams; and performing symbol-mapping by applying one of a plurality of gains to the multiplexed integrated bit streams.

According to an exemplary embodiment of the present invention, there is provided a wireless communication apparatus including: an error-correction-coding unit that performs an error-correction coding on a plurality of bit streams; and a symbol mapper that performs symbol mapping by applying one of a plurality of gains to the plurality of error-correction-coded bit streams.

According to an exemplary embodiment of the present invention, there is provided a wireless communication apparatus including: an error-correction-coding unit that performs an error-correction coding on a plurality of bit streams; a stream-arrangement unit that multiplexes a portion of the plurality of bit streams; and a symbol mapper that performs symbol mapping by applying one of a plurality of gains to the multiplexed bit streams.

According to an exemplary embodiment of the present invention, there is provided an unequal-error protection method including: performing symbol demapping on symbols to which one of a plurality of gains is applied; and performing error-correction decoding on a plurality of bit streams provided as a result of the symbol demapping.

According to an exemplary embodiment of the present invention, there is provided an unequal-error protection method including: performing symbol demapping on symbols to which one of a plurality of gains is applied; demultiplexing each of a predetermined number of integrated bit streams provided as a result of the symbol demapping; and performing error-correction decoding on a plurality of bit streams outputted as a result of the demultiplexing.

According to an exemplary embodiment of the present invention, there is provided a wireless-communication apparatus including: a symbol demapper that performs a symbol demapping on symbols to which one of a plurality of gains is applied; and an error-correction-decoding unit that performs error-correction decoding on a plurality of bit streams provided by the symbol demapper as a result of the symbol demapping.

According to an exemplary embodiment of the present invention, there is provided a wireless-communication apparatus including: a symbol demapper that performs symbol demapping on symbols to which one of a plurality of gains is applied; a stream-arrangement unit that de-multiplexes each of a predetermined number of integrated bit streams provided by the symbol demapper as a result of the symbol demapping; and an error-correction-decoding unit that performs error-correction decoding on a plurality of bit streams provided by the stream-arrangement unit as a result of the demultiplexing.

### BRIEF DESCRIPTION OF THE DRAWINGS

The above and other features and advantages of the present invention will become apparent by describing in detail preferred embodiments thereof with reference to the attached drawings in which:

FIG. 1 is a block diagram illustrating a wireless communication apparatus according to an exemplary embodiment of the present invention

FIG. 2 illustrates bits that constitute sub pixels according to an exemplary embodiment of the present invention.

FIGS. 3A to 3C illustrate a data-separation method according to an exemplary embodiment of the present invention.

FIG. 4 is a block diagram illustrating an unequal-error-protection unit according to an exemplary embodiment of the present invention.

FIG. 5 illustrates a sub-error-correction-coding unit according to an exemplary embodiment of the present invention.

FIG. 6 illustrates a convolutional encoder according to an exemplary embodiment of the present invention.

FIG. 7 illustrates the result of convolutional encoding according to an exemplary embodiment of the present invention.

FIG. 8 illustrates the result of puncturing according to an exemplary embodiment of the present invention.

FIG. 9 is a block diagram illustrating a sub-symbol mapper according to an exemplary embodiment of the present invention.

FIG. 10 illustrates a constellation according to an exemplary embodiment of the present invention.

FIGS. 11 to 17 illustrate a data-handling process according to an exemplary embodiment of the present invention.

FIG. 18 illustrates a data-handling process according to an exemplary embodiment of the present invention.

FIG. 19 illustrates a wireless communication apparatus according to an exemplary embodiment of the present invention.

FIG. 20 is a block diagram illustrating an unequal error-protection unit according to an exemplary embodiment of the present invention.

FIG. 21 is a flowchart illustrating a data-handling process according to an exemplary embodiment of the present invention.

### DETAILED DESCRIPTION OF THE INVENTION

Exemplary embodiments of the present invention will be described in detail with reference to the accompanying drawings.

The present invention may be understood more readily by reference to the following detailed description of exemplary embodiments and the accompanying drawings. The present invention may, however, be embodied in many different forms and should not be construed as being limited to the exemplary embodiments set forth herein. Rather, these embodiments are provided so that this disclosure will be thorough and complete and will fully convey the concept of the invention to those skilled in the art, whereas the present invention will only be defined by the appended claims. Like reference numerals refer to like elements throughout the specification.

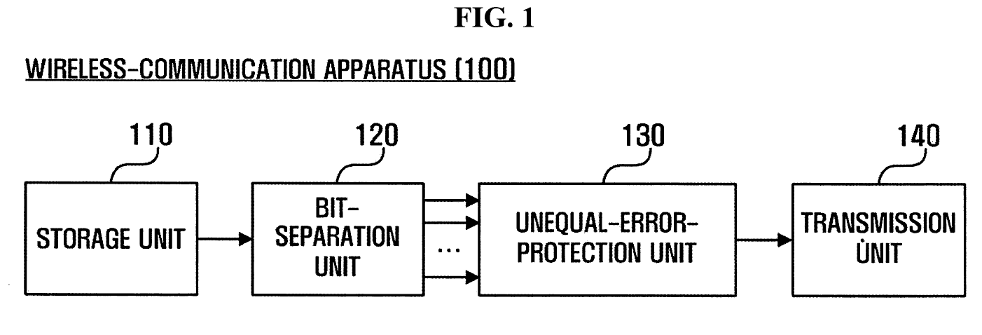

FIG. 1 is a block diagram illustrating a wireless-communication apparatus 100 according to an exemplary embodiment of the present invention. The wireless communication apparatus 100 includes a storage unit 110, a bit-separation unit 120, an unequal-error-protection unit 130, and a transmission unit 140.

The storage unit 110 stores data to be transmitted to other devices. For example, data that is stored in the storage unit 110 can be uncompressed audio and video (AV) data. Hereinafter, the description of the present invention will focus on uncompressed video data. Video data can consist of a set of sub-pixel values for each pixel. The sub-pixel values can be stored in various values depending on the color space (e.g., RGB color space or YCbCr color space), but to avoid repetition, the present invention is explained such that each pixel consists of three sub-pixels of R, G and B in the RGB color space. Further, in the case where the video data is gray (black and white) images, since there is only one sub-pixel element, one sub-pixel can constitute one pixel, or two or four sub-pixels can also constitute one pixel.

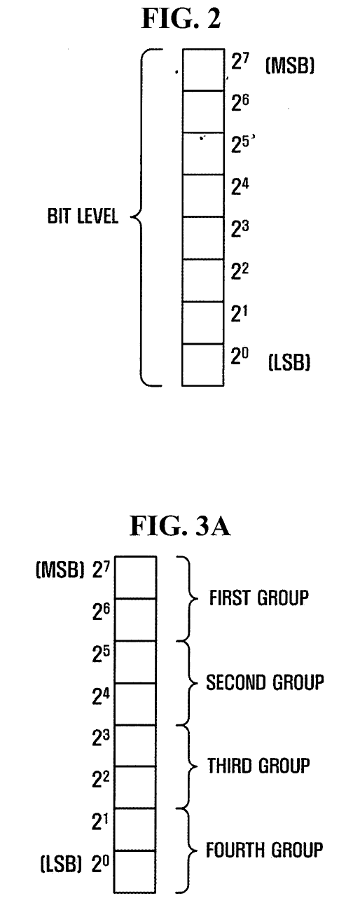

The bit-separation unit 120 classifies data according to its importance, and provides a plurality of bit streams. For example, in the case of 8-bit video images, as illustrated in FIG. 2, one sub-pixel element is expressed by 8 bits. Here, the bit that expresses the highest degree is the most significant bit (MSB), and the bit that expresses the lowest degree is the least significant bit (LSB). That is, each bit of the 8 bits of 1 byte has a different level of significance in restoring image (or sound) signals.

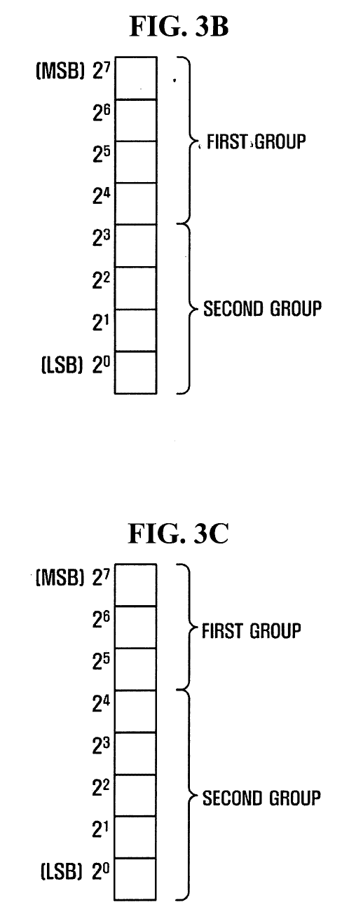

Hence, if data to be provided from the storage unit 110 is video data, the bit-separation unit 120 can separate each sub-pixel value (binary value) of the video data from high-degree (level) bits to low-degree (level) bits. In the case of 8-bit video data, since there are degrees from 2⁷ to 2⁰, the data can be separated into a total of 8 bits. Further, each bit does not necessarily need to be separated individually, but can be separated by groups after grouping into a predetermined number of bits. For example, as illustrated in FIG. 3A, sub-pixels of a 8-bit video image can be separated into a total of 4 groups by grouping every 2 bits, or as illustrated in FIG. 3B, the sub-pixels of the 8-bit video image can be separated into a total of 2 groups by 4 bit grouping. Further, as illustrated in FIG. 3C, the upper three bits can be separated as one group, and the lower five bits can be separated as another group in the 8-bit sub-pixel image value. The bit-separation process can be independently performed on each sub-pixel. Hence, the separated bits can constitute bit streams formed by the same bit groupings.

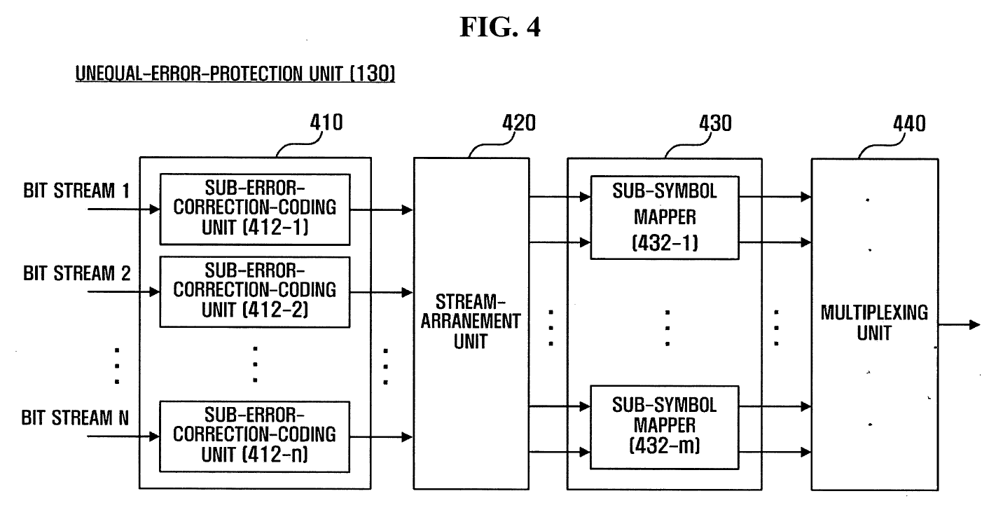

Referring to FIG. 1, the unequal-error-protection unit 130 performs channel-coding (error-correction coding) and symbol-mapping on a plurality of bit streams provided by the bit-separation unit 120. Here, the unequal-error-protection unit 130 gives an unequal-error-protection (UEP) effect to each bit stream depending on the significance of each of the plurality of bit streams. If an error occurs in bits whose significance is high during data transmission, because such an error occurrence can be more easily sensed by a user than the case where an error occurs in less significant bits, it is preferable for the error-protection effect to be improved for significant bits. The unequal-error-protection unit 130 will be described in more detail later with reference to FIGS. 4 to 17.

The transmission unit 140 modulates bit streams handled by the unequal-error-protection unit 130, and transmits the modulated bit streams to a wireless medium using the transmission frequency. For this, the transmission unit 140 can include an orthogonal frequency-division multiplexing (OFDM) modulation unit (not shown) and a RF-handling unit (not shown). The OFDM-modulation unit classifies inputted data as paralleled M-ary data symbols, the number of the M-ary data symbols being N, and the classified data symbols are modulated through each corresponding sub-carrier wave. Then, the OFDM-modulation unit generates one OFDM symbol by adding result values modulated through the sub-carrier wave. Here, the mutual orthogonality of sub-carrier waves is maintained. The RF-handling unit converts OFDM-converted data into analog data, and transmits the analog data to the wireless medium after handling the data using a predetermined RF signal (RF up-conversion).

FIG. 4 is a block diagram illustrating the unequal-error-protection unit 140 according to an exemplary embodiment of the present invention. The illustrated unequal-error-protection unit 140 includes an error-correction-coding unit 410, a stream-arrangement unit 420, a symbol mapper 430, and a multiplexing unit 440.

The error-correction-coding unit 410 performs error-correction coding on each bit stream in parallel. For this, the error-correction unit 410 can include a plurality of sub-error-correction-coding units 412-1 to 412-n (hereinafter, each sub-error-correction-coding unit is commonly referred to by reference numeral 412).

The sub-error-correction-coding unit 412 can perform error-correction coding on bit streams using different code rates. If inputted bit streams have the same significance, the same code rate can be used when the error-correction coding on each bit stream is performed. However, if the inputted bit streams have different significance, it is preferable that the more significant the streams are, the lower code rates are applied. Through this, the more significant the data is, the higher the error-protection level. That is, all sub-error-correction-coding units 142 can use the same code rate, or different code rates can be used. Further, only some of the sub-error-correction-coding units 142 can use the same code rate.

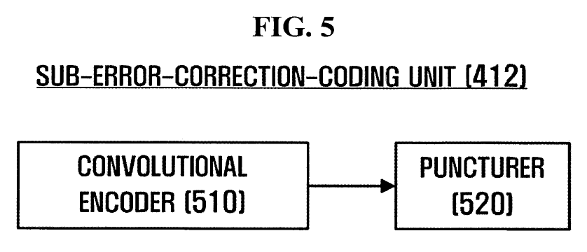

According to an exemplary embodiment of the present invention, the sub-error-correction-coding unit 142 can include a convolutional encoder 510 and a puncturer 520, as illustrated in FIG. 5.

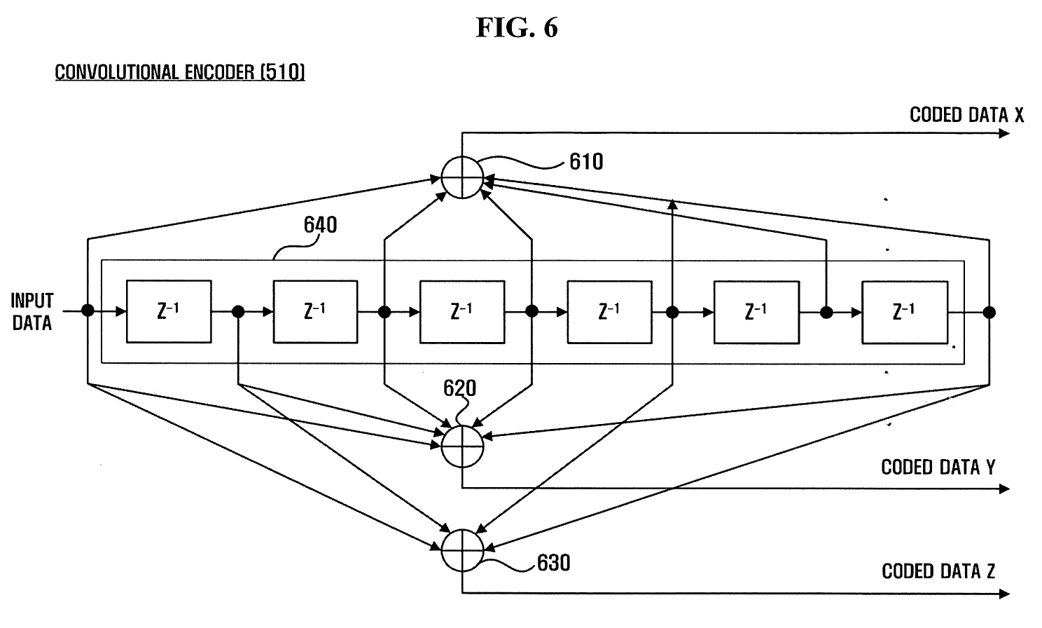

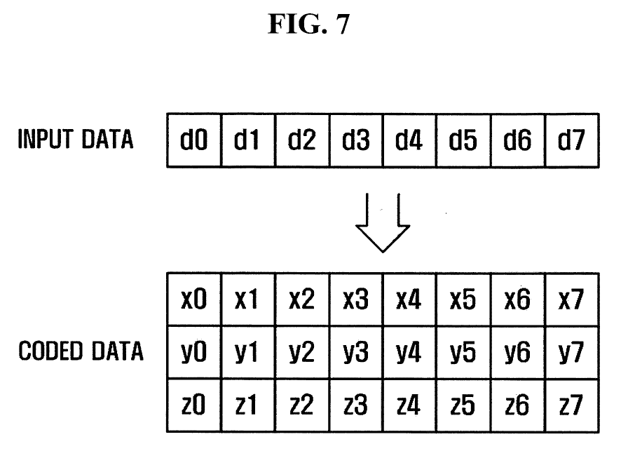

The convolutional encoder 510 performs convolutional encoding of inputted data. FIG. 6 illustrates the convolutional encoder 510 according to an exemplary embodiment of the present invention. In the illustrated convolutional encoder 510, the constraint length is 7, the delay memory is 6, the generator polynomial is g0=133o, g1=171o, and g2=145o, and the basic code rate is 1/3. The convolutional encoder 510 includes a first adder 610, a second adder 620, a third adder 630, and a delay register 640. The initial value of the delay register 640 can be set to 0, and the delay register 640 can be set as the initial value whenever a new data group is inputted. The number of bits included in data outputted by the convolutional encoder 510 of FIG. 6 is three times the number of bits included in the inputted data, which is illustrated in FIG. 7.

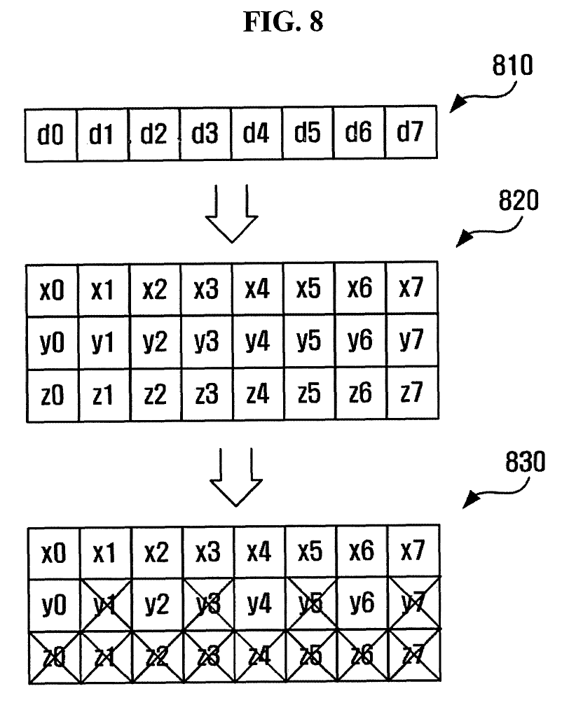

The puncturer 520 regulates the code rate of data outputted by the convolutional encoder 510. The code rate can be changed depending on the error-protection level. The embodiment of FIG. 8 illustrates the result (codeword 820) after the inputted data 810 is encoded by the convolutional encoder 510 with the code rate of 1/3, and the result 830 after the codeword 820 is punctured by the puncturer 520 with code rate of 2/3. In FIG. 8, d0 to d7 are bits of inputted data, and x0 to x7, y0 to y7, and z7 are bits of coded data. Discarded bits and outputted bits of coded data can be different depending on the code rate. In FIG. 8, discarded bits are distinguished by an “X”, and remaining bits are outputted.

Further, according to an exemplary embodiment of the present invention, the sub-error-correction-coding unit 412 can use a block-coding method such as a Reed-Solomon coding or a Bose-Chaudhuri-Hocquenghem (BCH) coding. Further, the sub-error-correction-coding unit 412 can use a concatenated coding method where the block-coding method and the convolutional-coding method are combined.

Referring to FIG. 4, the stream-arrangement unit 420 arranges the coded bit streams depending on the significance, and the bit streams can be transmitted to an appropriate symbol mapper 432 among sub-symbol mappers 432-1 to 432-m (hereinafter, each sub-symbol mapper will be referred to by reference numeral 432). That is, bit streams that can constitute I/Q pairs can be determined by the stream-arrangement unit 420. The stream-arrangement unit 420 can multiplex some bit streams into one bit stream.

In the embodiment of FIG. 4, it is illustrated that the unequal-error-protection unit 130 includes the stream-arrangement unit 420, but the stream-arrangement unit 420 is not an essential element. Hence, even though the symbol mapper 430 is described to handle bit streams transmitted from the stream-arrangement unit 420, the symbol mapper 430 can directly receive and handle bit streams from the error-correction-coding unit 410.

The symbol mapper 430 performs the symbol mapping for bits streams transmitted from the stream-arrangement unit 420. The symbol mapper 430 can include at least one sub-symbol mapper 432. If symbol mapper 430 includes a plurality of sub-symbol mappers 432, the symbol mapper 430 performs symbol mapping in parallel on the inputted plurality of bit streams. Here, two bit streams can be transmitted to one sub-symbol mapper 432 from among the plurality of bit streams transmitted from the stream-arrangement unit 420. Further, in the case where there is one sub-symbol mapper 432, the sub-symbol mapper 432 can be the symbol mapper 430.

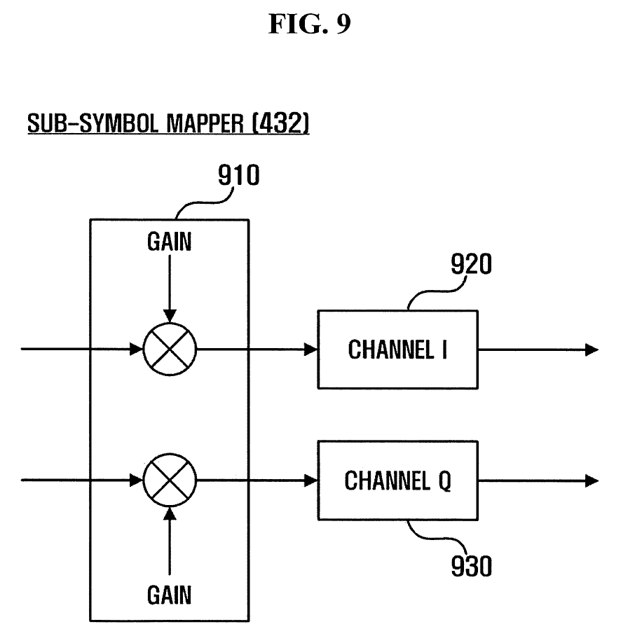

FIG. 9 illustrates the structure of a sub-symbol mapper 432 according to an exemplary embodiment of the present invention. The sub-symbol mapper 432 includes a gain-regulation unit 910, a channel I unit 920 that handles bits of gain-regulated bit streams so that the bits can correspond to the I-axis of the constellation, and a channel Q unit that handles bits of gain-regulated bit streams so that the bits can correspond to the Q-axis of the constellation.

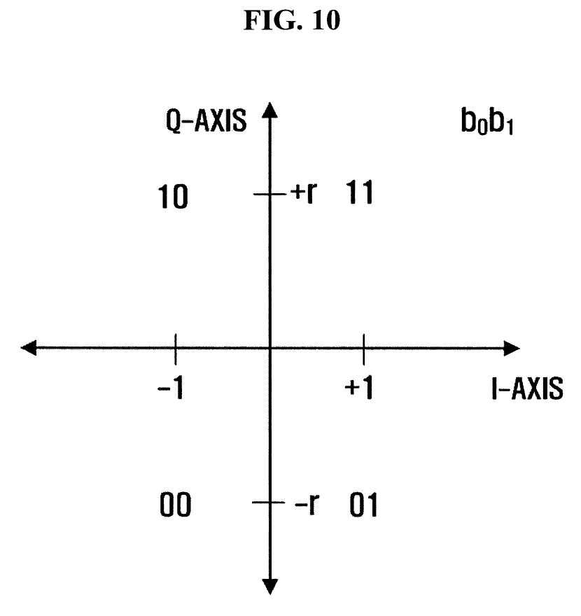

The gain-regulation unit 910 can apply different gain values on the two inputted bit streams. Here, the constellation can be expressed in a form where the I-axis and Q-axis have different distances, as illustrated in FIG. 10. As illustrated, when the parameter of the I-axis is 1, the parameter of the Q-axis can be expressed as r. Here, r is greater than 1, and the specific r value can be determined in advance depending on the required, unequal-error-protection level. Further, the gain-regulation unit 910 can apply the same gain value for the two inputted bit streams depending on the embodiment, and here, it can be expressed as r=1 in FIG. 10.

Further, sub-symbol mappers 432 can use different gain values. That is, gain values to be applied to bit streams inputted to the symbol mapper 430 can be determined by various implementation methods depending on the embodiment. Preferably, the more significant a bit stream is, the higher a gain value is applied, thus improving the error-protection level for bit streams of high significance.

Referring to FIG. 4, the multiplexing unit 440 multiplexes parallel data outputted from the symbol mapper 430, thereby outputting serial data.

Hereinafter, various embodiments of the bit-stream-handling process of the unequal-error-protection unit 130, which has been described with reference to FIGS. 4 to 10, will be described. The process where 8 bit streams are handled will be described in the following embodiment. However, the present invention is not limited to the following embodiments, and the cases where more or less than 8 bit streams are handled can be understood through the following embodiments.

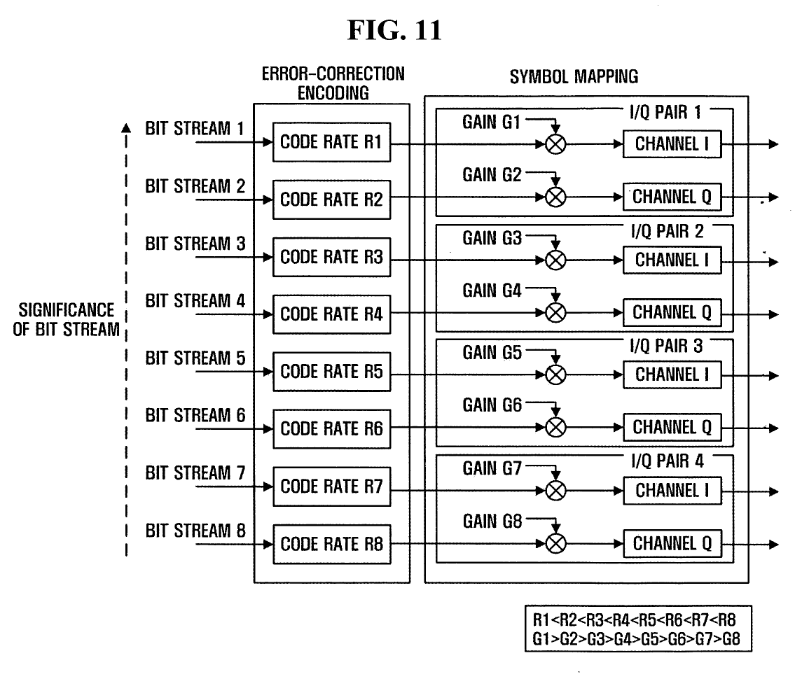

FIG. 11 illustrates the unequal-error-protection process according to an exemplary embodiment of the present invention. In the embodiment of FIG. 11, the order of the significance of bit streams is from bit stream 1 (the highest) to bit stream 8 (the lowest). First, each bit stream can be error-correction-coded with different code rates. In FIG. 11, r is the code rate to be applied to each bit stream, which shows that the higher significance a bit stream has, the lower code rate is applied.

Error-correction-coded bit streams are gain-regulated by different gains, respectively and are then handled by the I or Q channel. In FIG. 11, g is a gain, and it is shown that the more significant a bit stream, the higher the gain. Likewise, the more significant a bit stream, the higher the error-protection.

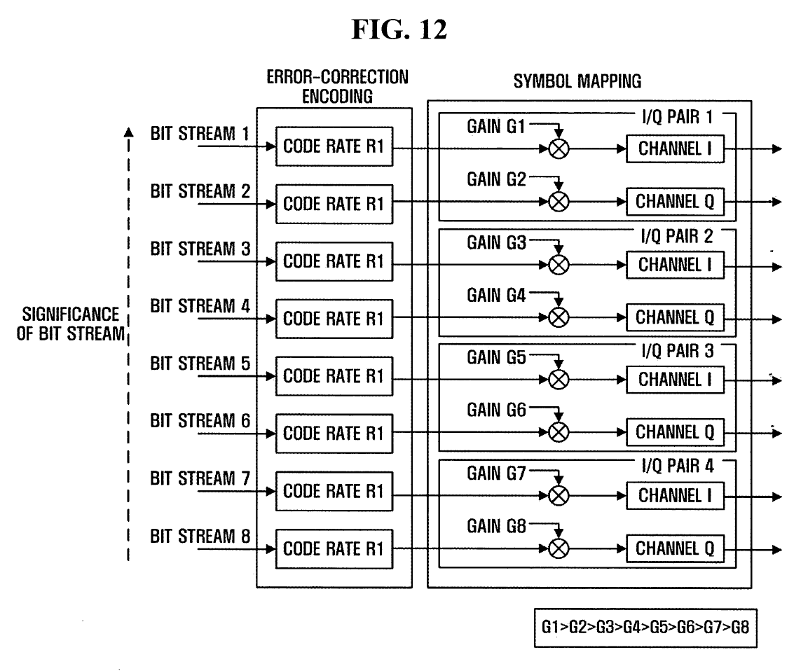

In the embodiment of FIG. 11, the case where the code rate and the gain to be applied to each bit stream are different has been described. However, as illustrated in FIG. 12, even though gains to be applied to each bit stream are different, the same code rate can be applied to all bit streams. Further, different code rates and the same gain can be applied to each bit stream.

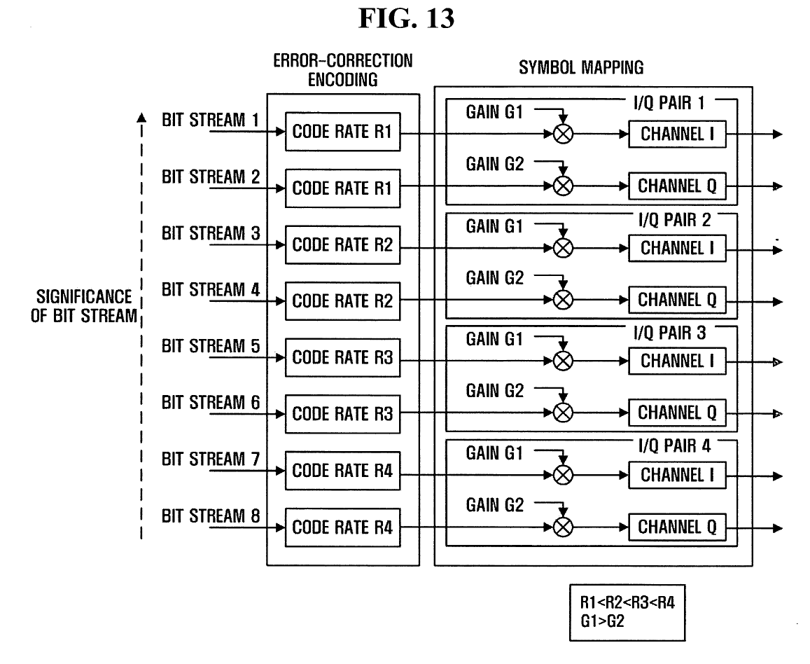

FIG. 13 illustrates an unequal-error-protection process according to another embodiment of the present invention. In the embodiment of FIG. 13, different code rates are applied to bit stream pairs. That is, the same code rate is applied to bit streams that constitute an I/Q pair, and different code rates are applied to bit streams that constitute another I/Q pair. Here, it is preferable for a higher code rate to be applied to bit-stream pairs having a high significance.

Further, in the symbol-mapping process, different gains are applied by bit streams to be handled by channel I, and bit streams to be handled by channel Q regardless of the I/Q pair.

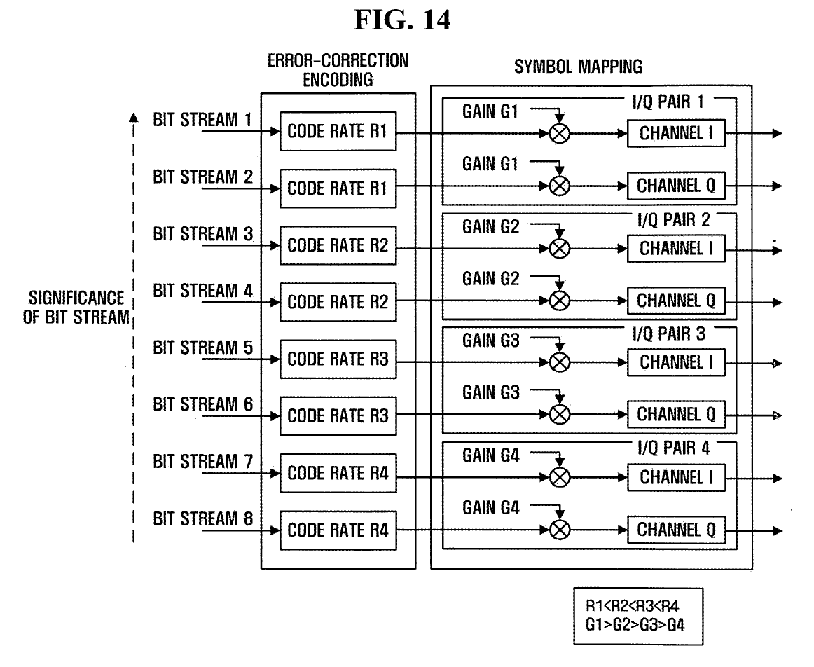

FIG. 14 illustrates an unequal-error-protection process according to another exemplary embodiment of the present invention. In the embodiment of FIG. 14, the error-correction process is the same as that of the embodiment of FIG. 13. However, in the present embodiment, the same gain is applied to bit streams that constitute the I/Q pair, and different gains are applied to bit streams that constitute other I/Q pairs.

Likewise, different error-protection effects can be generated by various combinations of the code rate r and the gain g to be applied to each bit stream. If the error-protection effect generated for a bit stream is expressed as P(r, g), the relationship among the error-protection effects can be established as in the following Equation 1, and one error-protection effect can be applied to each bit stream.

P(r1,g1)>P(r1,g2)>P(r2, g2)> . . . >P(rN,gN) (1)

Here, different error-protection effects do not necessarily need to be applied to each bit stream, thus the same error-protection effect can be generated for some bit streams depending on the embodiment.

The embodiments of FIGS. 11 to 14 show the case where gains are regulated in parallel on error-protection-coded bit streams. However, the present invention is not limited to such a case, and some number of the error-correction-coded bit streams can be multiplexed, and symbol mapping can be performed on the multiplexed bit streams.

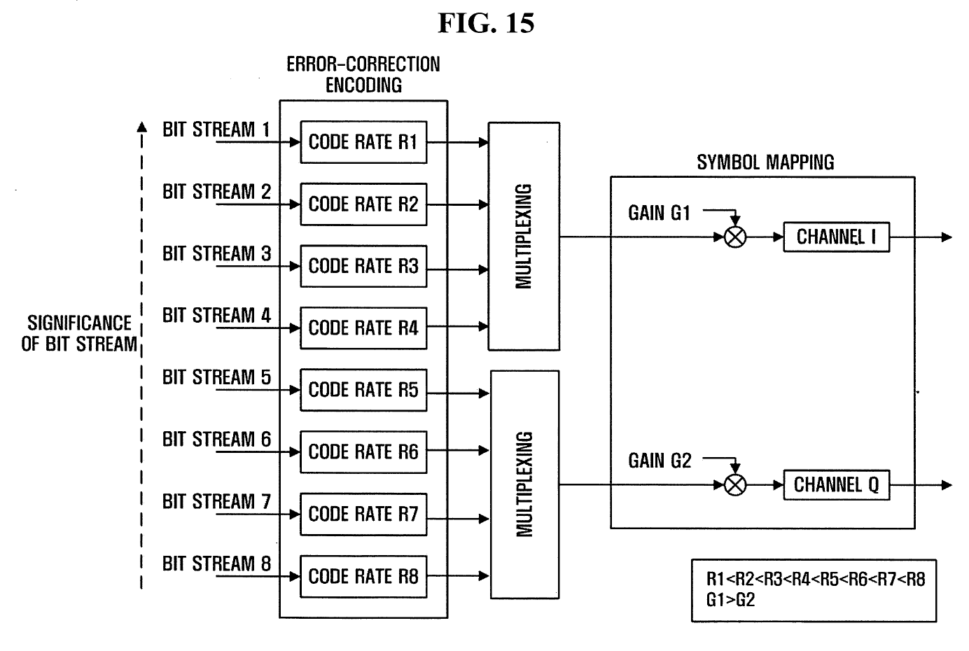

For example, as illustrated in FIG. 15, the high-ranking 4 bit streams and the low-ranking 4 bit streams of the error-correction-coded bit streams can be multiplexed, respectively, according to the order of the significance, thereby making two integrated bit streams, and different gains can be applied to the two integrated bit streams to handle the symbol mapping.

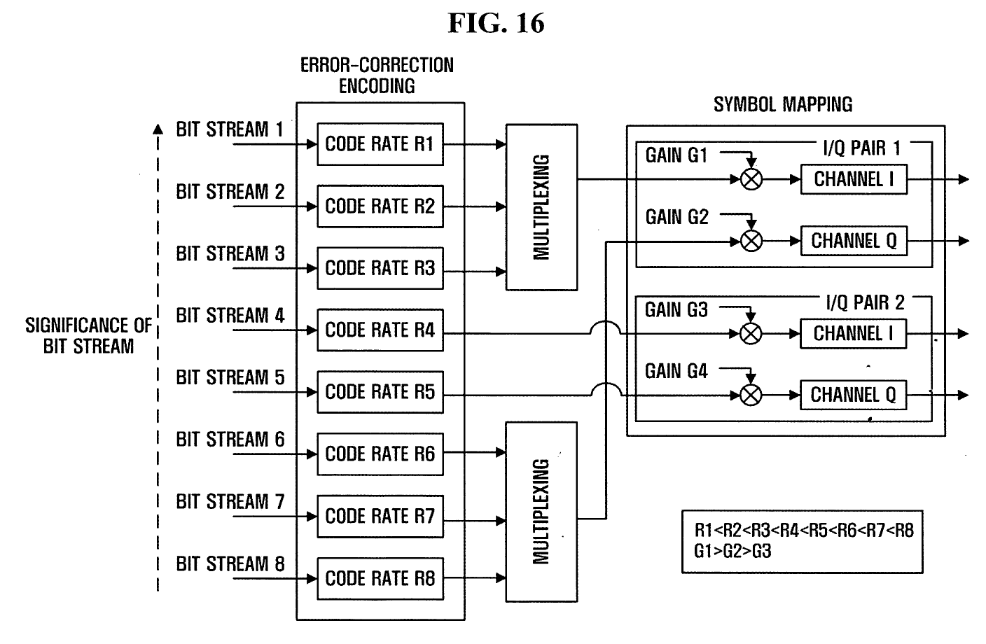

As another embodiment of the present invention, as illustrated in FIG. 16, the high-ranking 3 bit streams and the low-ranking 3 bit streams of the error-correction-coded bit streams can be multiplexed, respectively, according to the order of the significance, thereby making two integrated bit streams and handling the bit streams as an I/Q pair. Further, different gains can be applied to the integrated bit streams for symbol mapping. Here, the remaining error-correction-coded 2 bit streams can be handled as another I/Q pair, and symbol-mapping can be performed by applying the same gain on the bit streams.

Further, in the above description, each input bit stream has the same number of bits, but if different code rates are applied to bit streams when error-correction-coded, the number of bits of the error-correction-coded bit streams will then be different from each other. For example, if the error-correction coding is performed using the code rate 1/3, 6 coded bits are outputted for two input bits. However, if the error-correction coding is performed using the code rate 2/3, 3 coded bits are outputted for two input bits.

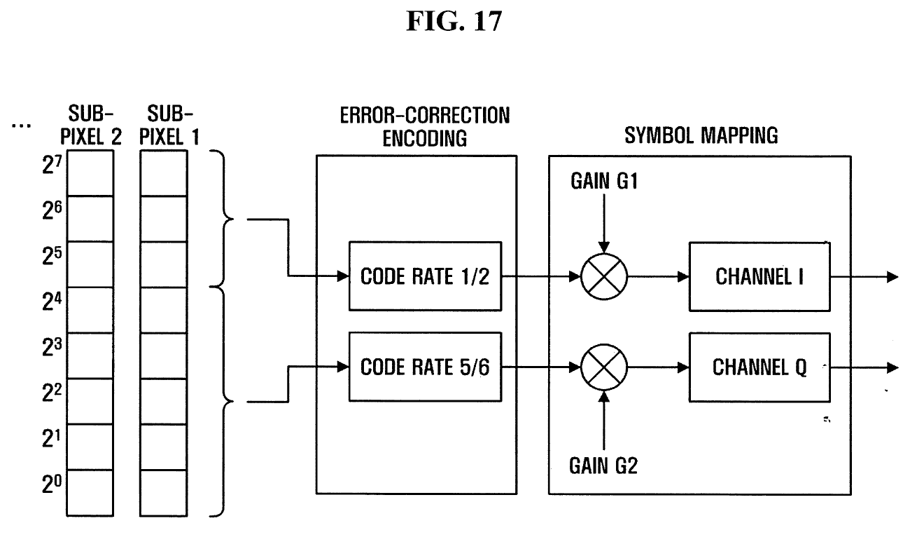

Further, bit streams outputted as a result of the error-correction coding all can have the same number of bits by regulating the number of bits of inputted bits streams and the code rate applied to each bit stream. For example, in the embodiment illustrated in FIG. 17, if the code rate 1/2 is applied to the bit stream having the high-ranking 3 bits, and the code rate 5/6 is applied to the bit stream having the low-ranking 5 bits out of 8-bit sub pixel values, the number of bits of the two bits streams inputted for error-correction coding is different, but the number of bits of bit streams outputted as a result of the error-correction coding will be the same. Hence, because the number of bits handled as channel I and channel Q when symbol-mapped is the same, the symbol mapping can be smoothly performed.

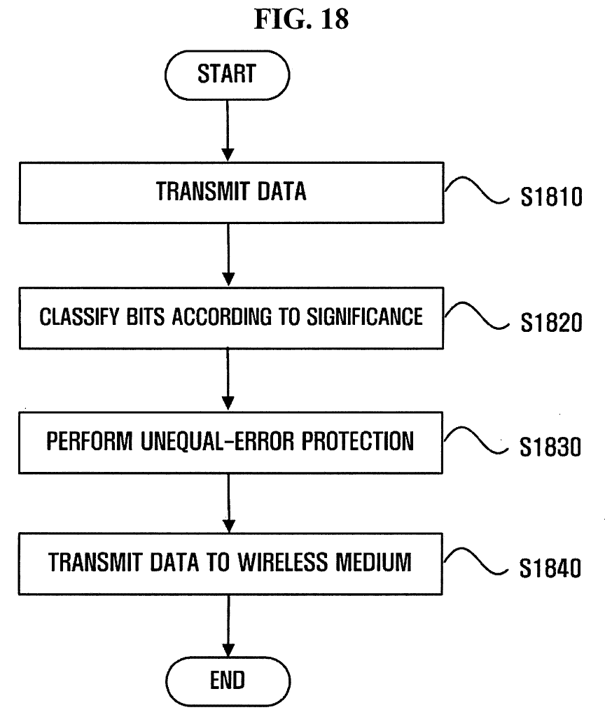

FIG. 18 is a flowchart illustrating a data-handling process according to an exemplary embodiment of the present invention. The illustrated process is performed by the wireless-communication apparatus 100 of FIG. 1.

If data is transmitted from the storage unit 110 S1810, the bit-classification unit 120 classifies the bits that constitute transmitted data according to significance S1820. Here, the classified bits are grouped and can each form one bit stream having one or varying significance levels.

Then, the unequal-error-protection unit 130 performs unequal-error protection according to the significance of the plurality of bit streams provided by the bit-classification unit 120 S1830. Here, the unequal error protection includes the error-correction coding and the symbol mapping, which are described in detailed with reference to FIGS. 4 to 17.

Then, the transmission unit 140 transmits data outputted by the unequal-error-protection unit 130 via a wireless medium S1840.

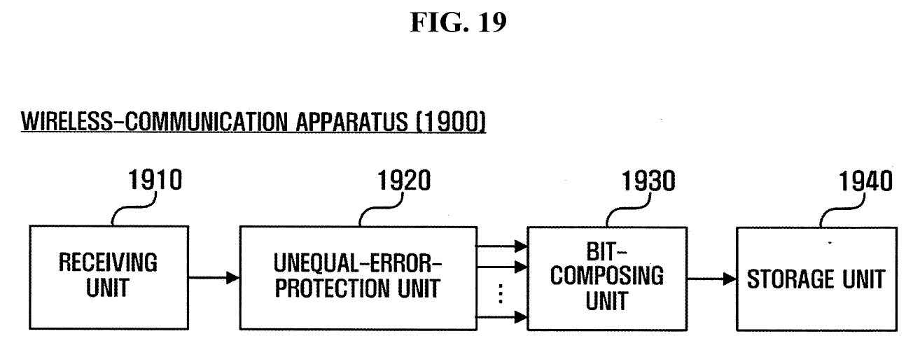

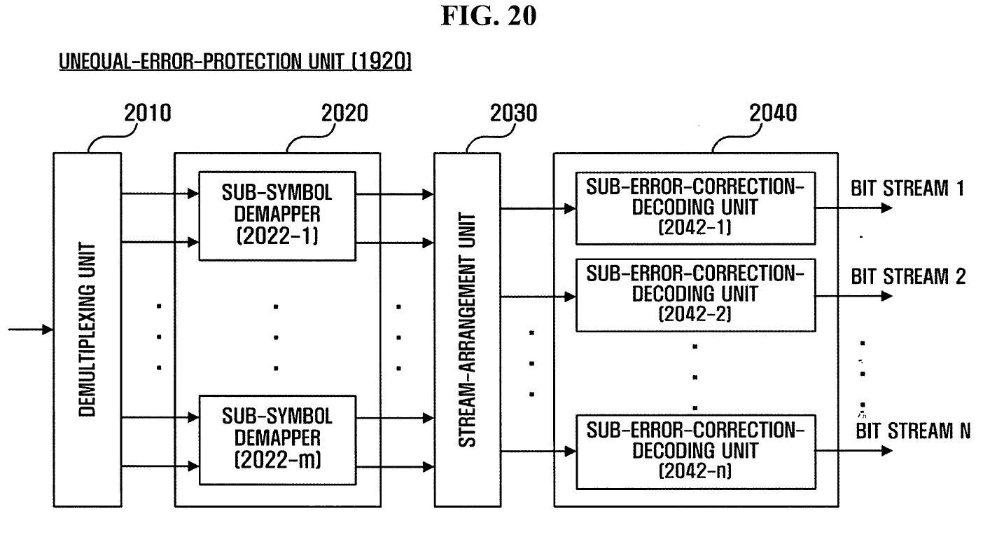

FIG. 19 is a block diagram illustrating a wireless-communication apparatus 1900 according to an embodiment of the present invention. The wireless-communication apparatus 1900 receives data transmitted from the wireless-communication apparatus 100 of FIG. 1, and handles the received data. The structure of the wireless-communication apparatus 1900 corresponds to that of the wireless-communication apparatus 100.

The wireless-communication apparatus includes a receiving unit 1910, an unequal-error-protection unit 1920, a bit-composing unit 1930, and a storage unit 1940.

The receiving unit 1910 receives data transmitted from other devices via a wireless medium. The receiving unit 1910 can include an orthogonal frequency-division multiplexing (OFDM)-demodulation unit (not shown) that RF-handles received data (RF-down conversion), and OFDM-demodulates RF-handled data with the RF-handling unit (not shown).

The unequal-error-protection unit 1920 performs the unequal-error protection on data transmitted from the receiving unit 1910. For this, the unequal-error-protection unit 1920 includes a demultiplexing unit 2010 that classifies inputted data into a plurality of bit streams, a symbol demapper 2020 that performs symbol demapping on a plurality of bit streams, a stream-arrangement unit 2030 that arranges or de-multiplexes bit streams transmitted from the symbol demapper 2020, and an error-correction-decoding unit 2040 that performs error-correction decoding on a plurality of bit streams transmitted from the stream-arrangement unit 2030.

Here, the symbol demapper 2020 can include at least one sub-symbol demapper 2022-1 to 2022-m (hereinafter, each sub-symbol demapper is commonly denoted by reference 2022), and the error-correction-decoding unit 2040 can include a plurality of sub-error-correction-decoding units 2032-1 to 2032-n (hereinafter, each sub-symbol demapper is commonly denoted by reference 2032). The sub-symbol demapper 2022 and the sub-error-correction-decoding unit 2042 correspond to the sub-symbol mapper 432 and the sub-error-correction-coding unit 412. A detailed description of the unequal-error protection performed by the unequal-error-protection unit 1920 is omitted here, but those in the art will be able to implement the unequal-error-protection unit 1920 that performs the function corresponding to the unequal-error-protection described above with reference to FIGS. 11 to 17.

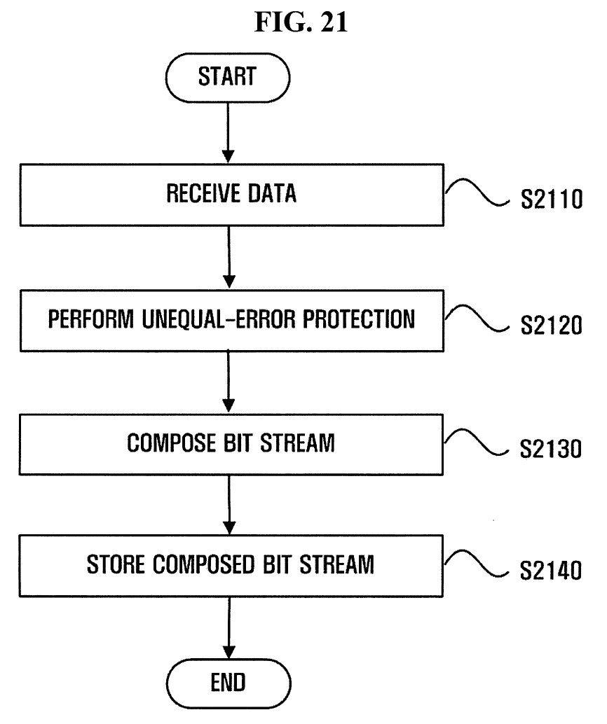

FIG. 21 is a flowchart illustrating a data-handling process according to an exemplary embodiment of the present invention. The illustrated process is performed by the wireless-communication apparatus 1900 of FIG. 19.

If the receiving unit 1910 receives data through a wireless medium S2110, the unequal-error-protection unit 1920 performs the unequal-error protection on the received data S2120. Here, because the more important the data is, the higher the error-protection level is kept in the handling of the data, so that even though an error occurs in the received data, the finally-restored data is not significantly affected by such an error.

Then, the bit-composing unit 1930 composes a plurality of bit streams transmitted from the unequal-error-protection unit 1920 S2130, and the storage unit 1940 stores the composed bit streams S2140.

Further, the present invention is not limited to stored composed bit streams, and composed bit streams can be used. For example, if the received data is uncompressed video data, the wireless-communication apparatus 1900 can display images consisting of composed bit streams.

The elements of the wireless-communication apparatus 100 of FIG. 1 and the wireless-communication apparatus 1900 of FIG. 19 can be implemented as modules. The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Further, processes described with reference to FIGS. 11 to 18, and 21 can be implemented as an application program by those of ordinary skill in the art. By recording such a program in a storage medium readable by a computer and executing the program on a computer, the embodiments described in the present specification and other similar embodiments can be implemented, and such cases are included in the scope of the present invention.

It should be understood by those of ordinary skill in the art that various replacements, modifications and changes may be made in the form and details without departing from the spirit and scope of the present invention as defined by the following claims. Therefore, it is to be appreciated that the above described embodiments are for purposes of illustration only and are not to be construed as limitations of the invention.

The method and apparatus of the present invention can transmit data efficiently and stably, which is advantageous.

What is claimed is:

1. An unequal-error-protection method comprising:
performing error-correction coding on a plurality of bit streams; and
performing symbol mapping by applying one of a plurality of gains to each of the plurality of error-correction-coded bit streams.

2. The method of claim 1, wherein the performing of the symbol-mapping comprises independently applying a gain to each of the plurality of error-correction-coded bit streams.

3. The method of claim 1, wherein the performing of the symbol-mapping comprises applying different gains to bit streams to be handled as channel I and channel Q, out of the plurality of error-correction-coded bit streams.

4. The method of claim 3, wherein the performing of the symbol-mapping further comprises applying a first gain to bit streams to be handled as channel I, and applying a second gain to bit streams to be handled as channel Q.

5. The method of claim 1, wherein the performing of the symbol-mapping comprises applying the same gain to bit streams that constitute the same I/Q pair, out of the plurality of error-correction-coded bit streams.

6. The method of claim 5, wherein the performing of the symbol-mapping further comprises applying different gains to bit streams that constitute different I/Q pairs, out of the plurality of error-correction-coded bit streams.

7. The method of claim 1, wherein the performing of the symbol-mapping comprises applying lower gains as the significance rises among the plurality of error-correction-coded bit streams.

8. The method of claim 1, wherein the performing of the error-correction coding in parallel comprises performing error-correction coding by applying different code rates to the plurality of bit streams.

9. The method of claim 1, wherein the performing of the error-correction coding in parallel comprises performing error-correction coding by applying the same code rate to bit steams that constitute the same I/Q pair, out of the plurality of bit streams.

10. The method of claim 9, wherein the performing of the error-correction coding in parallel further comprises performing error-correction coding by applying different code rates to bit streams that constitute different I/Q pairs, out of the plurality of bit streams.

11. The method of claim 1, wherein the performing of the error-correction coding in parallel comprises performing error-correction coding by gradually applying higher code rates as the significance decreases, among the plurality of bit streams.

12. The method of claim 1, wherein the number of bits of the plurality of bit streams is different from each other, and the number of bits of bit streams outputted as a result of the error-correction coding is the same.

13. The method of claim 1,
wherein the plurality of bit steams include a first bit stream that includes 3 upper-degree bits, and a second bit stream that includes 5 lower-degree bits, among sub-pixel values that constitute 8-bit video data in the uncompressed state, and
wherein the performing of the error-correction coding in parallel comprises performing error-correction coding by applying the code rate 1/2 to the first bit stream and applying the code rate 5/6 to the second bit stream.

14. An unequal-error protection method comprising:
performing error-correction coding on a plurality of bit streams;
multiplexing the plurality of bit streams into a predetermined number of integrated bit streams; and
performing symbol-mapping by applying one of a plurality of gains to the multiplexed integrated bit streams.

15. The method of claim 14, wherein the multiplexing multiplexes the upper half of the bit streams into a first integrated bit stream in an order such that bit streams of higher significance come first, and multiplexes the lower half of the bit streams into a second integrated bit stream.

16. The method of claim 14, wherein the multiplexing comprises multiplexing the critical number of upper bit streams into the first bit stream, multiplexing the critical number of lower bit streams into the second bit stream, in an order such that bit streams of higher significance come first among the plurality of bit streams, and multiplexing remaining bit streams into either a third integrated bit stream or a third and a fourth integrated bit stream divided by halves.

17. The method of claim 16, wherein the performing of the symbol mapping performs symbol mapping using the first integrated bit stream and the second integrated bit stream as an I/Q pair, and performs the symbol mapping using the third integrated bit stream and the fourth integrated bit stream as an I/Q pair.

18. The method of claim 17, wherein the gains applied to the first integrated bit stream and the second integrated bit stream are different from each other, and the gains applied to the third integrated bit stream and the fourth integrated bit stream are the same.

19. The method of claim 14, wherein the performing of the error-correction coding in parallel comprises performing error-correction coding by applying different code rates to the plurality of bit streams.

20. The method of claim 14, wherein the performing of the error-correction coding in parallel comprises performing error-correction coding by applying gradually higher code rates as the significance rises among the plurality of bit streams.

21. A wireless communication apparatus comprising:
an error-correction-coding unit that performs error-correction coding on a plurality of bit streams; and
a symbol mapper that performs symbol mapping by applying one of a plurality of gains to the plurality of error-correction-coded bit streams.

22. The apparatus of claim 21, wherein the symbol mapper independently applies a gain to each of the plurality of error-correction-coded bit streams.

23. The apparatus of claim 21, wherein the symbol mapper applies different gains to bit streams to be handled as channel I, and bit streams to be handled as channel Q, among the plurality of error-correction-coded bit streams.

24. The apparatus of claim 23, wherein the symbol mapper applies a first gain to bit streams to be handled as channel I, and a second gain to bit streams to be handled as channel Q, among the plurality of error-correction-coded bit streams.

25. The apparatus of claim 21, wherein the symbol mapper applies the same gain to bit streams that constitute the same I/Q pair, among the plurality of error-correction-coded bit streams.

26. The apparatus of claim 25, wherein the symbol mapper applies different gains to bit streams that constitute different I/Q pairs, among the plurality of error-correction-coded bit streams.

27. The apparatus of claim 21, wherein the symbol mapper applies gradually lower gains as the significance of bit streams rises, among the plurality of error-correction-coded bit streams.

28. The apparatus of claim 21, wherein the error-correction-coding unit performs error-correction coding by applying different code rates to the plurality of bit streams.

29. The apparatus of 21, wherein the error-correction-coding unit performs error-correction coding by applying the same code rate to bit streams that constitute the same I/Q pair among the plurality of bit streams.

30. The apparatus of claim 29, wherein the error-correction-coding unit performs error-correction coding by applying different code rates to bit streams that constitute different I/Q pairs among the plurality of bit streams.

31. The apparatus of claim 21, wherein the error-correction-coding unit performs error-correction coding by applying gradually higher code rates as the significance of bit streams increases, among the plurality of bit streams.

32. The apparatus of claim 21, wherein the number of bits of the plurality of bit streams is different from each other, and the number of bits of the bit streams outputted as a result of the error-correction coding is the same.

33. The apparatus of claim 21,
wherein the plurality of bit streams include a first bit stream that includes 3 upper-degree bits, and a second bit stream that includes 2 lower-degree bits, among sub-pixel values that constitute uncompressed 8-bit video data, and
wherein the error-correction-coding unit performs error-correction coding by applying the code rate 1/2 to the first bit stream, and applying the code rate 5/6 to the second bit stream.

34. A wireless communication apparatus comprising:
an error-correction-coding unit that performs error-correction coding on a plurality of bit streams;
a stream-arrangement unit that multiplexes a portion of the plurality of bit streams; and
a symbol mapper that performs symbol mapping by applying one of a plurality of gains to the multiplexed bit streams.

35. The apparatus of claim 34, wherein the stream-arrangement unit multiplexes the upper half of the bit streams into a first integrated bit stream and the lower half of the bit streams into a second integrated bit stream in an order such that bit streams of higher significance come first among the plurality of bit streams.

36. The apparatus of claim 34, wherein the stream-arrangement unit multiplexes the critical number of upper bit streams into the first bit stream, multiplexes the critical number of lower bit streams into the second bit stream, in an order such that bit streams of higher significance come first among the plurality of bit streams, and multiplexes remaining bit streams into either a third integrated bit stream or a third and a fourth integrated bit stream divided by halves.

37. The apparatus of claim 36, wherein the symbol mapper performs symbol mapping using the first integrated bit stream and the second integrated bit stream as an I/Q pair, and performs symbol mapping using the third integrated bit stream and the fourth integrated bit stream as an I/Q pair

38. The method of claim 37, wherein the gains applied to the first integrated bit stream and the second integrated bit stream are different from each other, and the gains applied to the third integrated bit stream and the fourth integrated bit stream are the same.

39. The method of claim 34, wherein performing the error-correction-coding comprises performing error-correction coding by applying different code rates to the plurality of bit streams.

40. The method of claim 34, wherein the error-correction-coding unit performs error-correction coding by applying gradually higher code rates as the significance increases, among the plurality of bit streams.

41. A recording medium that records a computer-readable program that executes the method of claim 1.

42. A recording medium that records a computer-readable program that executes the method of claim 14.

43. An unequal-error protection method comprising:
performing a symbol demapping on symbols to which one of a plurality of gains is applied; and
performing an error-correction decoding on a plurality of bit streams provided as a result of the symbol demapping.

44. An unequal-error protection method comprising:
performing a symbol demapping on symbols to which one of a plurality of gains is applied;
demultiplexing each of a predetermined number of integrated bit streams provided as a result of the symbol demapping; and
performing the error-correction decoding on a plurality of bits streams outputted as a result of the demultiplexing.

45. A wireless-communication apparatus comprising:
a symbol demapper that performs symbol demapping on symbols to which one of a plurality of gains is applied; and
an error-correction-decoding unit that performs error-correction decoding on a plurality of bit streams provided by the symbol demapper as a result of the symbol demapping.

46. A wireless-communication apparatus comprising:
a symbol demapper that performs a symbol demapping on symbols to which one of a plurality of gains is applied;
a stream-arrangement unit that de-multiplexes each of a predetermined number of integrated bit streams provided by the symbol demapper as a result of the symbol demapping; and
an error-correction-decoding unit that performs error-correction decoding on a plurality of bit streams provided by the stream-arrangement unit as a result of the demultiplexing.

47. A recording medium that records a computer-readable program that executes the method of claim 43.

48. A recording medium that records a computer-readable program that executes the method of claim 44.
